(19) United States
(12) Patent Application Publication
(10) Pub. No.: US 2014/0100907 A1
(43) Pub. Date: Apr. 10, 2014

(54) Project Management System

(71) Applicant: Suz-Tsung Wei, New Taipei City (TW)

(72) Inventor: Suz-Tsung Wei, New Taipei City (TW)

(21) Appl. No.: 14/046,979

(22) Filed: Oct. 6, 2013

(30) Foreign Application Priority Data
Oct. 8, 2012 (TW) 101137176
Sep. 12, 2013 (CN) 201310415100.6

(51) Int. Cl. G06Q 10/06

(52) U.S. Cl. CPC G06Q 10/06315
USPC 705/7.23

(57) ABSTRACT

A project management system is provided. The project management system includes an information access module, a performance management module, a performance index determination module, and a performance result output module. The project management system is configured to manage at least one project and is adapted for integrating a plurality of projects, so as to control and manage the project management performance of a department or inter-department and multiple levels. The project management system can use non-monetary units, such as working hours, number of work package, or number of activity, to evaluate performance.

### FIELD OF THE INVENTION

The present invention relates to a project management system, especially a project management system measuring the performance based on the number of the working packages, number of activities, and working hours.

### BACKGROUND OF THE INVENTION

In recent years, for the development of new products, new market expansion and the acquisition of new customers, as well as internal organizational change, process reengineering and information system implementation, and other such non-routine matters, whether in the planning and implementation of strategic aspect or in that of the manage aspect, the business community usually uses project management. The objective is to through the project management processes and methods, given the limited resources investment and risk management costs, make the project on schedule to achieve the desired goal. That's why the project management is important for the business.

While conducting project management performance measurement, generally the earned value management (also referred as EVM) is used to measure the performance of project management. EVM is to compare the actual completed work with the estimated working plans and provide an evaluation of a project implementation performance and measure how far away from completion. During the EVM process, the estimated working plans and the actual completed works would be transformed into currency values for comparison. The project managers can enter data, for example labor costs, material costs, indirect costs, activity, completion date occurred during executing the project, via an information access module into the project database, to complete the graph as shown in FIG. 1. Wherein the curve PV (Planned Value) refers to the estimated cost for the planned completed work, the curve EV (Earned Value) refers to the actual estimated cost for the actual completed work, and the curve AC (Actual Cost) refers to the actual cost for the actual completed work. Measurement of the performance of the project is done by the differences between the curve PV's value, curve EV's value, and curve AC's value.

Currently in practical money is used as the unit to measure the performance of the project. However, this will cause the curve PV, curve EV, and curve AC distortion or even failure. Moreover, in practical many projects do not have material costs, the investment of labor hours are not estimated and controlled, and some project execution does not use money as a unit to measure the performance, all these will cause the traditional EVM have certain restrictions on its applications. In addition, a person may also be responsible and participating in several other projects, but the traditional EVM performance mode only estimates a single project instead of multiple projects. Furthermore, there are many projects running in a company and the projects usually are cross-organizational, inter-professional and interdisciplinary in their nature, so the traditional EVM is unable to do an effective performance management interdepartmentally for multi-projects and for all the personnel responsible for all the projects. So, a solution for the above problem becomes the most urgent need.

The traditional project management performance baseline includes scope baseline, schedule baseline, cost baseline, and quality baseline and the traditional EVM uses schedule baseline and cost baseline. Therefore, the traditional EVM has certain restrictions on its applications. The project scope is the work required to complete and deliver a product, services, or results of features and functionality. The scope baseline is a baseline has never been drawn by anyone, so it is impossible to make a specific range of performance index for the scope baseline.

In the traditional human resource management, the resource histograms are used to represent resource loading in the project life cycle, then according to what actually happened at least one of the theory of constraints (TOC), resource leveling, or resource smoothing techniques is chosen to solve the problem. Theory of constraints is when the resources conflicts to each other, the conflicting resource preferentially be used in the critical path, and then re-scheduling, but this results in delay of the project schedule. Resource leveling is to make the resource demands in the project cycle more stable or to make the resource demand less than the maximum usage, but this also results in delay of the project schedule. Resource Smoothing is to smooth the resource loading without delaying the project schedule.

However, the prior art methods are based on a single project, in fact, the general business always have hundreds of projects progressing at the same time with hundreds or even thousands of people involved in these projects. Because these people are from different sections, from different levels, of multi-disciplinary, cross-country or even from the outside of company, it is difficult to do resource planning, resource load and efficient manpower arrangements. The traditional resource leveling cannot solve these problems and the existing project management software could not come up with better solutions, so a solution for the above problems becomes the most urgent need.

### SUMMARY OF THE INVENTION

The purpose of the present invention is to provide a project management system. The project management system can measure the performance based on non-monetary units, and can achieve interdepartmental, cross-management level and cross-project management.

According to the above objects and other objects, the present invention provides a project management system. The project management system is configured to manage at least one project and adapted for integrating multiple projects in order to control a department or interdepartmental and multi-level project management performance. The project management system includes an information access module, a performance management module, a performance index determination module, and a performance result output module. The information access module is configured for at least one user to input multiple pieces of project information, each piece of project information corresponds to one of projects, and the project information includes multiple pieces of work unit information. A work unit can be a work breakdown structure, a work package or an activity. The work unit information includes a planned numbers of WBS, a earned numbers of WBS, a planned numbers of work package, a earned numbers of work package, an planned numbers of activity, and an earned numbers of activity. The performance management module compares the work unit planned value with the work unit earned value to get their differences, and transforms the difference to a performance index. The performance index determination module determines the project's performance results reached according to the performance index. In the present application, the work unit planned value means in a predetermined time the number of the work units planned to be completed and the work unit earned value means in the predetermined time the number of the work units actual completed.

The performance management module includes a work breakdown structure performance management module, a work package performance management module, and an activity performance management module. The work breakdown structure performance management module compares the planned numbers of WBS with the earned numbers of WBS to get their difference and transforms the difference to a first performance index. The work package performance management module compares the planned numbers of work package with the earned numbers of work package to get their difference and transforms the difference to a second performance index. The activity performance management module compares the planned numbers of activity and the earned numbers of activity to get their differences and transforms the differences to a third performance index. With the first performance index, the second performance index and the third performance index, the performance index determination module can determine the project's performance results reached. In addition, the performance result output module shows the performance results from the performance index determination module.

The first performance index includes a work breakdown structure variance value or/and a work breakdown structure performance index. The work breakdown structure variance value means the earned numbers of WBS minus the planned numbers of WBS and the work breakdown structure performance index means the earned numbers of WBS divided by the planned numbers of WBS.

The second performance index includes a work package variance value or/and a work package performance index. The work package variance value means the earned numbers of work package minus the planned numbers of work package. The work package performance index means the earned numbers of work package divided by the planned numbers of work package.

The third performance index includes an activity variance value or/and an activity performance index. The activity variance value means the earned numbers of activity minus the planned numbers of activity. The activity performance index means the earned numbers of activity divided by the planned numbers of activity.

When the performance index determination module determines that the work breakdown structure variance value is negative or that the work breakdown structure performance index is lower than 1.0, the performance result output module would output a warning of underperformance. When the performance index determination module determines that the work package variance value is negative or that the work package performance index is lower than 1.0, the performance result output module would output a warning of underperformance. When the performance index determination module determines that the activity variance value is negative or that the activity performance index is lower than 1.0, the performance result output module would output a warning of underperformance.

In the aforesaid project management system, the work breakdown structure information also includes a work breakdown structure planned hour value, a earned hours of WBS, a actual hours of WBS, a planned hours of work package, a earned hours of work package, a actual hours of work package, an planned hours of activity, an earned hours of activity, and an actual hours of activity. Furthermore, the performance management module includes a work breakdown structure hour performance management module, a work package hour performance management module, and an activity hour performance management module. The work breakdown structure hour performance management module compares the planned hours of WBS, the earned hours of WBS and the actual hours of WBS to get their differences, and transforms the differences into a fourth performance index. The work package hour performance management module compares the planned hours of work package, the earned hours of work package and the actual hours of work package to get their differences, and transforms the differences into a fifth performance index. The activity hour performance management module compares the planned hours of activity, the earned hours of activity and the actual hour value of work activity, and transforms the differences into a sixth performance index. Moreover, the performance index determination module determines the performance results according to the fourth performance index, the fifth performance index and the sixth performance index.

The fourth performance index includes at least one of the followings: a work breakdown structure hour variance value, a fourth hour variance value, a work breakdown structure hour performance index, and a fourth hour performance index. The work breakdown structure hour variance value means the earned hours of WBS minus the planned hours of WBS. The fourth hour variance value means the earned hours of WBS minus the actual hour value. The work breakdown structure hour performance index means the earned hours of WBS divided by the planned hours of WBS. The fourth hour performance index means the earned hours of WBS divided by the actual hour value.

The fifth, performance index includes at least one of the followings: a work package hour variance value, a fifth hour variance value, a work package hour performance index, a fifth hour performance index. The work package hour variance value means the earned hours of work package minus the planned hours of work package. The fifth hour variance value means the earned hours of work package minus the actual hour value. The work package hour performance index means the earned hours of work package divided by the planned hours of work package. The fifth hour performance index means the earned hours of work package divided by the actual hour value.

The sixth performance index includes at least one of the followings: an activity hour variance value, a sixth hour variance value, an activity hour performance index, a sixth hour performance index. The activity hour variance value means the earned hours of activity minus the planned hours of activity. The sixth hour variance value means the earned hours of activity minus actual hour value. The activity hour performance index means the earned hours of activity divided by the planned hours of activity. The sixth hour performance index means the earned hours of activity divided by the actual hour value.

When the performance index determination module determines that the fourth hour variance value is negative or that the work breakdown structure hour variance value is negative or that the fourth hour performance index is lower than 1.0 or that the work breakdown structure hour performance index is smaller than 1.0, performance result output module would output a warning of underperformance. When the performance index determination module determines that the fifth hour variance value is negative or that the work package hour variance value is negative or that the fifth hour performance index is lower than 1.0 or that the work package hour performance index is lower than 1.0, the performance result output module would output a warning of underperformance. When the performance index determination module determines that the activity hour variance value is negative or that the sixth hour variance value is negative or that the activity hour performance index is lower than 1.0 or that the sixth work hour performance index is lower than 1.0, the performance result output module outputs a warning of underperformance.

The project management system further includes a user interface and the project information further includes the information about the relationship between all the work breakdown structures, the work packages, the activities and project members in charge of. The user interface displays the work breakdown structures, the work packages and the activities that a project member is in charge of. Therefore, the project managers can know all the work breakdown structures, the work packages and the activities that this project member currently is in charge of and can regard the work breakdown structures, the work packages and the activities that this project member currently in charge as one project.

The above and other aspects, features, and advantages of the present invention will become more apparent from the following detailed description when taken in conjunction with the accompanying drawings.

### BRIEF DESCRIPTION OF THE DRAWINGS

FIG. 1 shows a curve diagram for the traditional actual earned value management.

FIG. 2A shows a project structure.

FIG. 2B shows a project information structure.

FIG. 2C shows a more extensive project plan framework.

FIG. 2D shows a project's Organization Breakdown Structure.

FIG. 3A shows a system architecture diagram of the project management system according to the first embodiment of the present invention.

FIG. 3B shows a flow chart of creating a new project in the project management system.

FIG. 4A shows an output result of the work package variance value.

FIG. 4B shows an output result of the work package value performance index.

FIG. 5A shows an output result of the work package hour variance value and the third hour variance value.

FIG. 5B shows an output result of the work package hour performance index and the third hour performance index.

FIG. 6 shows a project management system according to the second embodiment of the present invention.

FIG. 7 shows a user interface of the project management system according to one embodiment of the present invention.

FIG. 8 shows a user interface of the project management system according to another embodiment of the present invention.

FIG. 9 is a histogram of human resources.

FIG. 10 shows a project management system according to the third embodiment of the present invention.

FIG. 11 shows a functional organizational structure of an organization.

FIG. 12 shows a project hierarchy structure.

FIG. 13 shows a user interface, which presents the ongoing multiple projects being undertaken by the company and the project members in charge of.

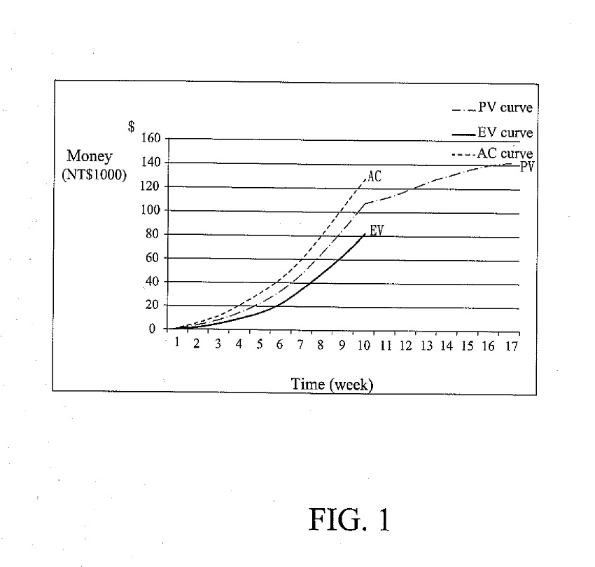

### DETAILED DESCRIPTION OF PREFERRED EMBODIMENTS

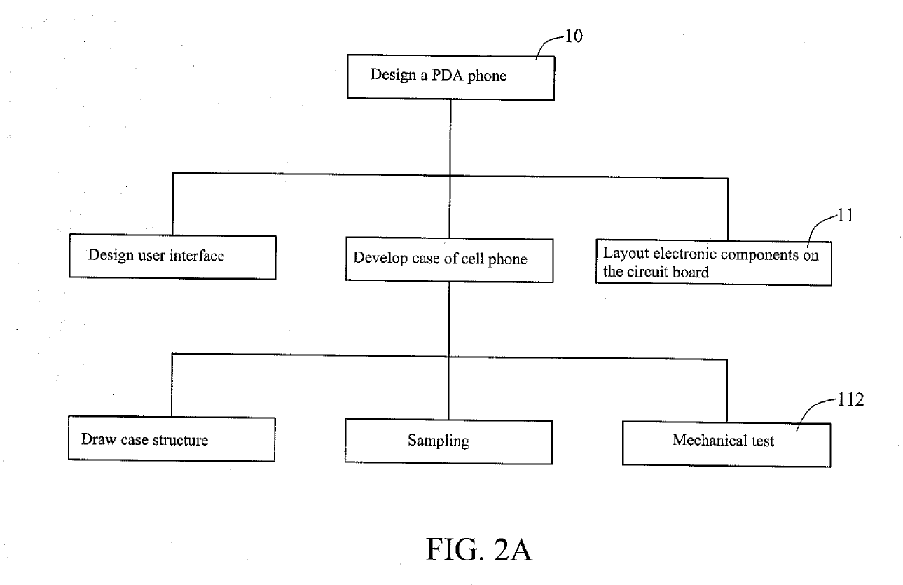

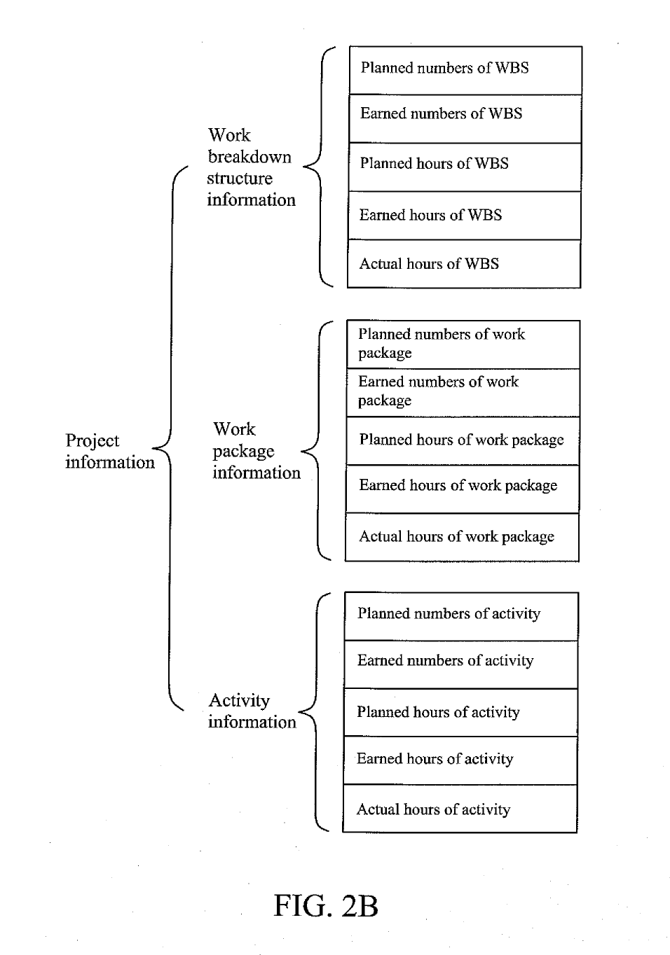

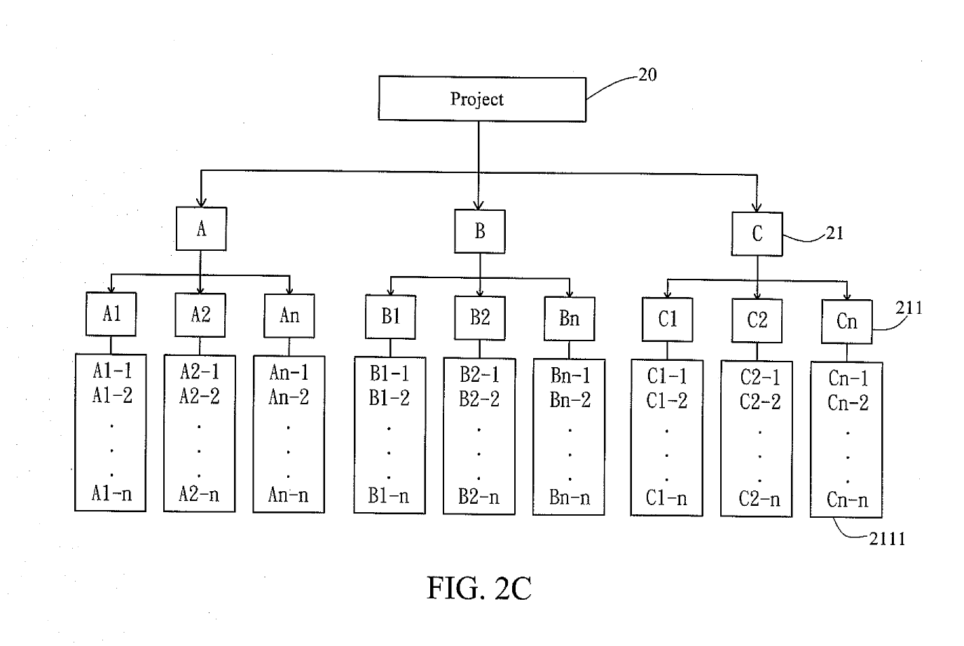

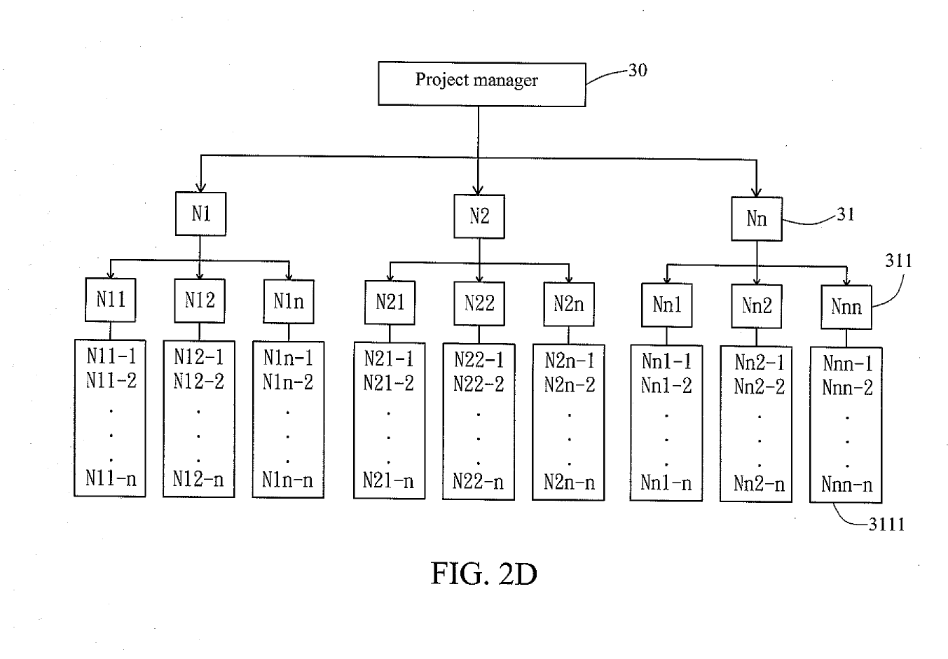

In this embodiment the term “project” refers to creating an unique product or a service by temporary effort and each project can be broke down into a plurality of layers of work units. These work units comprise work breakdown structures, work packages and activities. In other words, the scope of project can be disassembled layer by layer, dismantled to the bottom of smaller units to facilitate estimations of human resources, cost, and work schedule, and the disassembling/dismantling process can be called creating work breakdown structure (WBS). The work breakdown structure is a multilayer structure and can be called project range or product range, the amount of layers of work breakdown structures depends on the project's properties, size and complexity. The unit for work breakdown structures in the bottom layer is called work package. Planning operating elements for achieving the work packages is called activities definition. Each work package can be broke down into at least one activity (usually can be broke down into multiple activities), by this an activities list can be derived. For example, please see the FIG. 2A, project 10 “design a PDA phone” may include the work packages 11 of “design user interface”, “develop cases of cell phone” and “layout electronic components on the circuit board” and the work package “develop cases of cell phone” may also further be defined by the activities 112 of “draw case structure”, “sampling”, and “mechanical test”, etc. Then the responsibilities are assigned to project members, and then estimations of work hours, work period and material cost can be completed.

Refer to FIG. 2C, FIG. 2C shows a more extensive project plan framework. In the project 20 of FIG. 2C, the top layer represents the final product or service to be delivered in the project. Pursuant to the foregoing method of breaking down work breakdown structures, the project 20 may be broke down into a plurality of first-level work breakdown structure units 21 which are the product or service details to be completed, if necessary, each of the first-level work breakdown structure units 21 may be broke down into a plurality of second-level work breakdown structure units 211 need to be completed; if the second-level work breakdown structure units 211 do not need to be broke down, the second-level work breakdown structure units 211 would be called work packages, then the work packages 211 may be broke down into a plurality of activities 2111.

Refer to FIG. 2D, FIG. 2D shows a project's organization breakdown structure, the organization breakdown structure is corresponding to the project work breakdown structure in FIG. 2C. Refer to FIG. 2C and FIG. 2D, a project manager 30 is responsible for coordinating the overall project management of the project 20, and the first-level project members 31 are responsible for the work of the first level 21, the second-level project members 311 are responsible for the work of the second level 211 and the third-level project members 3111 are responsible for activities 2111. For example, the project members N1 are responsible for work breakdown structure units A, the project members N22 are responsible for work packages B2 and project members Nnn-2 are responsible for activities Cn-2.

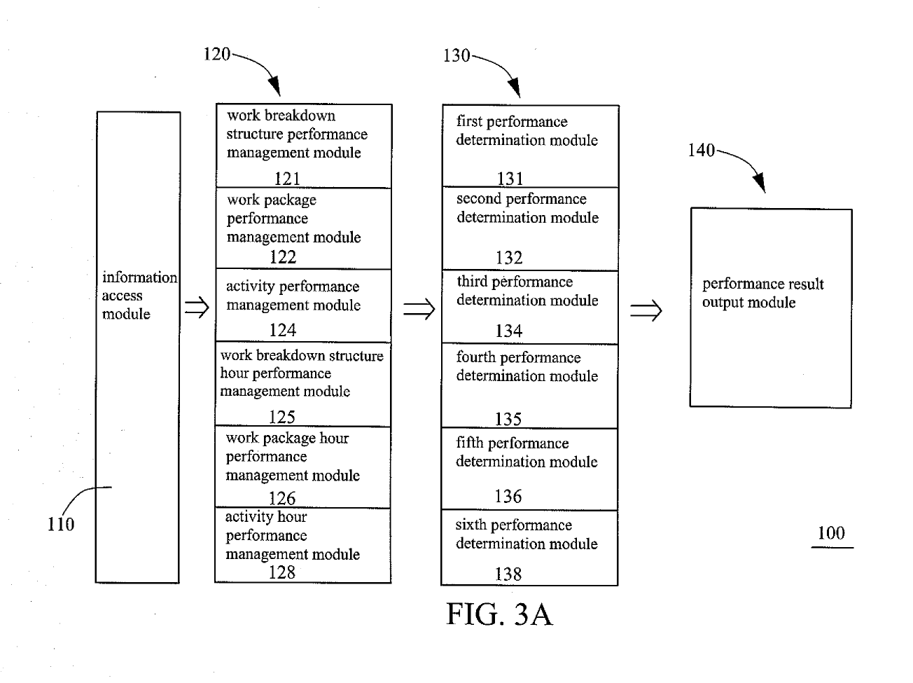

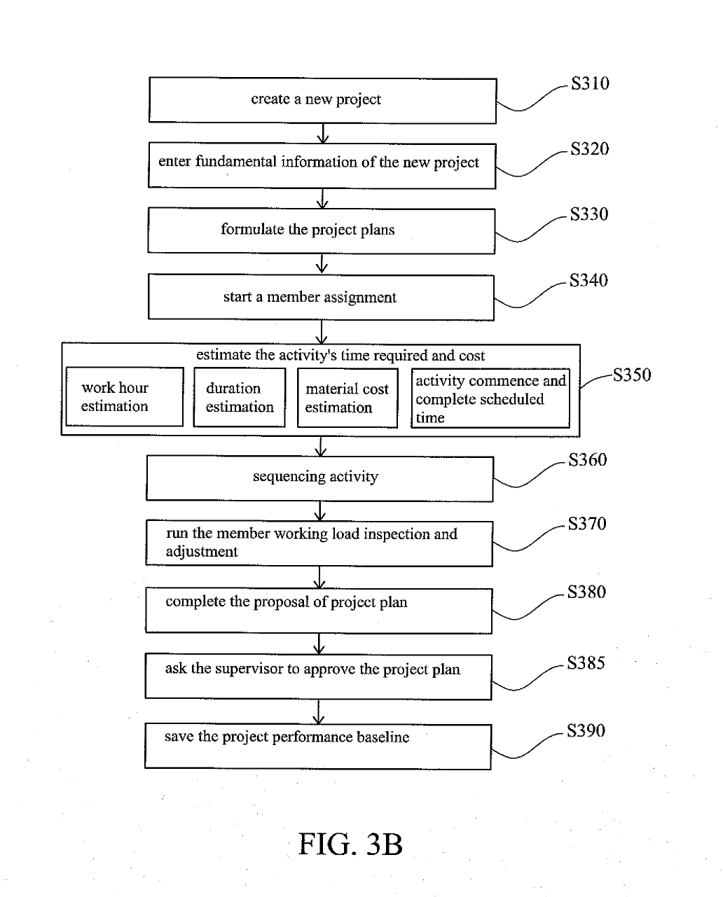

Refer to FIG. 3A, FIG. 3A shows a system architecture diagram of the project management system of first embodiment of the present invention. The project management system 100 includes an information access module 110, a performance management module 120, a performance index determination module 130 and a performance result output module 140. The project management system 100 can be used to manage a plurality of projects whose structures are shown as FIG. 2A or FIG. 2C.

The information access module 110 can be a personal computer, a smart phone or any other electronic device for information input, the user can use the information access module 110 to input project information.

Refer to FIG. 3B, FIG. 3B shows the processes of creating a new project in the project management system. Please refer to FIG. 3A and FIG. 3B, the first step S310 is performed to create a new project, and then step S320 is performed to enter fundamental information of the new project, these fundamental information includes project name, project target and project background. Thereafter, step S330 is performed to formulate the project plans, the step S330 include completion of breaking down the project into work breakdown structures, i.e. establishing a project structure as shown in FIG. 2C, then step S340 is performed to start a member assignment so as to specify the responsible members for each of the various levels of work breakdown structure and work package and each activity, and then step S350 is performed to estimate the activity's time and cost required, for example: work hour estimation, duration estimation, material cost estimation, activity commence and complete scheduled time. Next, step S360 is performed to sequence activity.

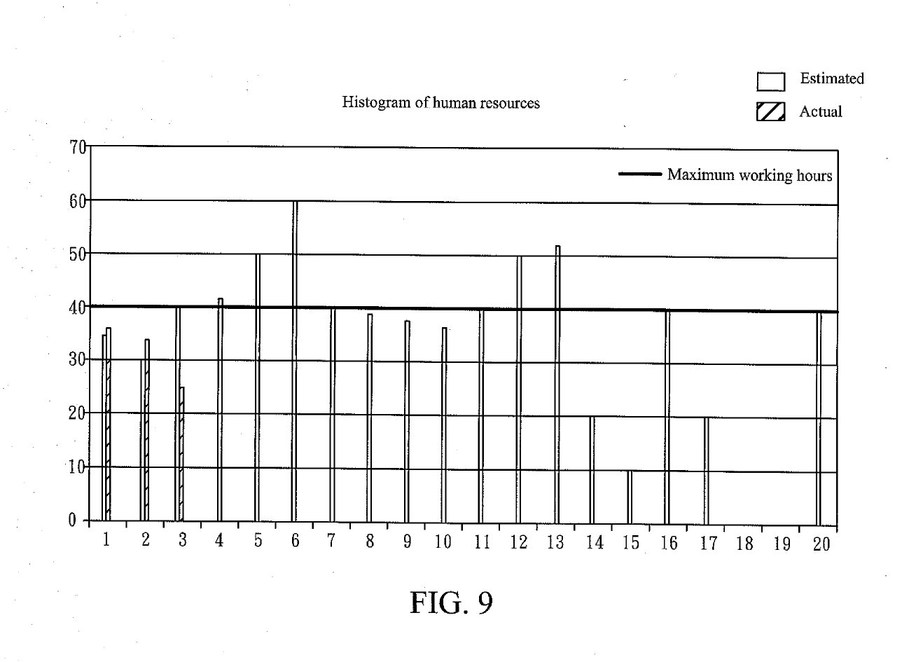

Then, step S370 is performed to run the member working load inspection and adjustment. When performing the step S370, the user interface will display the human resource histogram, as shown in FIG. 9, to check everyone's working load. If a project member's working load exceeds a threshold value, the working load of this project member would be adjusted until a reasonable working load of human resources is achieved, and then the project plan can be submitted to a supervisor to get approval. Then, step S380 is performed to complete the project plan. Next, step S385 is performed to have the supervisor's approval of the project plan. Finally, step S390 is performed to save the project performance baseline. The step S390 would create a performance baseline for each performance index of each project and the planned values for each project member regarding the work breakdown structure information, the work package information and the activity information according to the information entered in the step S350 and S360. In FIG. 2B: the planned values of the work breakdown structure information include planned numbers of WBS and planned hours of WBS; the planned values of the work package information include planned numbers of work package and planned numbers of work package; and the planned values of the activity information include planned numbers of activity and planned hours of activity.

Furthermore, the work breakdown structure information further includes a earned numbers of WBS, a earned hours of WBS and a actual hours of WBS. The work package information includes a earned numbers of work package, a earned hours of work package and a actual hours of work package. Also, the activity information includes an earned numbers of activity, an earned hours of activity and an actual hours of activity. The terminology used in the present patent application is defined as the below as shown in Table 1.

TABLE 1

| Terminology | Definition |
|---|---|
| Planned numbers of | The budgeted numbers of WBS |
| WBS | planned to be completed |
| Earned numbers of | The actual numbers of WBS |
| WBS | actually completed |
| Planned numbers of | The budgeted numbers of work |
| work package | package planned to be completed |
| Earned numbers of | The budgeted numbers of work |
| work package | package actually completed |
| Planned hours of WBS | The budgeted hours of WBS to be |
| | completed |
| Earned hours of WBS | The earned hours of WBS actually |
| | completed |
| Actual hours of WBS | The actual hours of WBS actually |
| | completed |
| Planned hours of work | The budgeted hours of work |
| package | package planned to be completed |
| Earned hours of work | The budgeted hours of work |
| package | package actually completed |
| Actual hours of work | The actual hours of work package |
| package | actually completed |
| Planned numbers of | The budgeted numbers of activity |
| activity | planned to be completed |
| Earned numbers of | The budgeted numbers of activity |
| activity | actually completed |
| Planned hours of | The budgeted hours of activity to be |
| activity | completed |
| Earned hours of | The earned hours of activity |
| activity | actually completed |
| Actual hours of activity | The actual hours of activity actually |
| | completed |
| Planned cost of | The budgeted material cost of work |
| material | to be completed |
| Earned cost of material | The budgeted material cost of work |
| | actually completed |
| Actual cost of material | The actual material cost of work |
| | actually completed |

Refer to FIG. 3A, the performance management module 120 includes a work breakdown structure performance management module 121, a work package performance management module 122 and an activity performance management module 124. The work breakdown structure performance management module 121 is configured to manage the work breakdown structure related performance, the work package performance management module 122 is configured to manage the work package related performance and the activity performance management module 124 is configured to manage the activity related performance. As the work package is of the lowest bottom level of the work breakdown structure, the work package performance management module 122 can be regarded as part of the work breakdown structure performance management module 121.

In the ongoing process of a project, the project manager responsible for this project or the responsible person for the activities of this project will input the project information representative of the implementation such as actual hours, actual cost of material, actual start date and/or actual finish date etc., through the information access module 110 into the project management system 100, to form the earned numbers of WBS, the earned numbers of work package, the earned numbers of activity, the actual activity hours and/or the actual cost of material, etc.

In one embodiment, the work breakdown structure performance management module 121 compares the planned numbers of WBS with the earned numbers of WBS to get their difference and transforms the difference into a first performance index. The work package performance management module 122 compares the planned numbers of work package with the earned numbers of work package to get their difference and transforms the difference into a second performance index. And, the activity performance management module 124 compares the planned numbers of activity with the activity earn value to get their difference and transforms the difference into a third performance index. Hereinafter will have more detailed description for the first performance index, the second performance index and the third performance index.

The first performance index includes a work breakdown structure variance value and a work breakdown structure performance index, the work breakdown structure variance value is defined as:

work breakdown structure variance value=earned numbers of WBS−planned numbers of WBS.

The work breakdown structure performance index is defined as:

work breakdown structure performance index=earned numbers of WBS/planned numbers of WBS.

The second performance index includes a work package variance value and a work package performance index, the work package variance value is defined as:

work package variance value=earned numbers of work package−planned numbers of work package.

work package performance index is defined as:

work package performance index=earned numbers of work package/planned numbers of work package.

The third performance index includes an activity variance value and an activity performance index, the activity variance value is defined as:

activity variance value=earned numbers of activity−planned numbers of activity.

activity performance index=earned numbers of activity/planned numbers of activity.

After the first performance index, the second performance index and third performance index are calculated, the calculated value would be transferred to the performance index determination module 130. In this embodiment, the performance index determination module 130 includes a first performance determination module 131, a second performance determination module 132 and a third performance determination module 134. The first performance determination module 131 corresponds to the first performance index, the second performance determination module 132 corresponds to the second performance index and the third performance determination module 134 corresponds to the third performance index. The first performance determination module 131, the second performance determination module 132 and the third performance determination module 134 would respectively in accordance with the first performance index, the second performance index and the third performance index to determine the project's performance result reached.

Then, the performance result output module 140 will output performance results determined by the performance index determination module 130. For example, a result showing a negative work package variance value or a work package performance index smaller than 1.0 means that the work packages earned number is less than the work packages planned number. Then, the second performance determination module 132 can determine that the second performance index is undesirable and transfer the determination result to the performance result output module 140, so the performance result output module 140 can output a warning of to underperformance. This underperformance warning output, for example, will be displayed on the screen, such as using a red font or display lights. More specifically, if the performance is undesirable, the underperformance warning output can be a warning by the lights in the performance result output table.

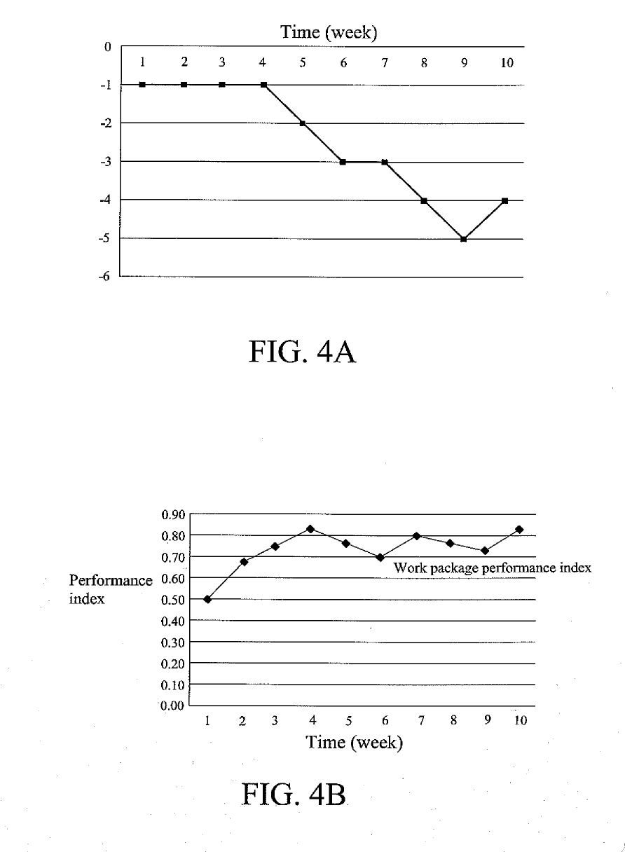

Refer to FIG. 4A and FIG. 4B, FIG. 4A shows a work package variance value output result and FIG. 4B shows a work package performance index output result. FIG. 4A and FIG. 4B respectively show the changes of the work package variance value and the work package performance index over time.

Similarly, a result showing a negative work breakdown structure variance value or a work breakdown structure performance index less than 1.0 means that the earned numbers of WBS is less than the work breakdown structure planned earned value. Then the first performance determination module 131 can determine that the first performance index is undesirable and transfer the determination result to the performance result output module 140, so the performance result output module 140 can output a warning of underperformance.

In another example, the result showing a negative activity variance value or an activity performance index less than 1.0 means that the earned numbers of activity is less than the planned numbers of activity. Then, the third performance determination module 134 can determine that the third performance index is undesirable and transfer the determination result to the performance result output module 140, so the performance result output module 140 can output a warning of underperformance.

In addition, when the project is progressing, the project manager can enter the hours spent on each activity into the project management system 100 to produce project information of the actual hours of activity and the actual hours of work package. In a preferred embodiment shown in FIG. 3A, the performance management module 120 further includes a work breakdown structure hour performance management module 125, a work package hour performance management module 126 and an activity hour performance management module 128. The work breakdown structure hour performance management module 125 compares the planned hours of WBS, the earned hours of WBS and the actual hours of WBS to get their differences, thereby outputting a fourth performance index. The work package hour performance management module 126 compares the planned hours of work package, the earned hours of work package and the actual hours of work package, thereby outputting a fifth performance index. The activity hour performance management module 128 compares the planned hours of activity, the earned hours of activity and the actual hours of activity to get their differences and transforms the differences into a sixth performance index. Hereinafter there will be more detailed description for the fourth performance index, the fifth performance index and the sixth performance index.

The fourth performance index includes a work breakdown structure hour variance value, a fourth hour variance value, a work breakdown structure hour performance index and a fourth hour performance index, wherein:

The work breakdown structure hour variance value=earned hours of WBS−planned hours of WBS.

The fourth hour variance value=planned hours of WBS−actual hours of WBS.

The work breakdown structure hour performance index=earned hours of WBS/planned hours of WBS.

The fourth hour performance index=earned hours of WBS/actual hours of WBS.

The fifth performance index includes a work package hour variance value, a fifth hour variance value, a work package hour performance index and a fifth hour performance index, therein:

The work package hour variance value=earned hours of work package−planned hours of work package.

The fifth hour variance value=earned hours of work package−actual hours of work package.

The work package hour performance index=earned hours of work package/planned hours of work package.

The fifth hour performance index=earned hours of work package/actual hours of work package.

The sixth performance index includes an activity hour variance value, a sixth hour variance value, an activity hour performance index and a sixth hour performance index, and the activity hour variance value is defined as:

The activity hour variance value=earned hours of activity−planned hours of activity.

The sixth hour variance value=earned hours of activity−actual hours of activity.

The activity hour performance index=earned hours of activity/planned hours of activity.

The sixth hour performance index=earned hours of activity/actual hours of activity.

After the fourth performance index, the fifth performance index and the sixth performance index are calculated, the calculated value can be transferred to the performance index determination module 130. In a preferred embodiment, the performance index determination module 130 includes the fourth performance determination module 135, the fifth performance determination module 136 and the sixth performance determination module 138. The fourth performance determination module 135 corresponds to the fourth performance index, the fifth performance determination module 136 corresponds to the fifth performance index and the sixth performance determination module 138 corresponds to the six performance index. The fourth performance determination module 135, the fifth performance determination module 136 and the sixth performance determination module 138 can respectively in accordance with the fourth performance index, the fifth performance index and the sixth performance index determine the project's performance results reached.

Then, the performance result output module 140 can output performance results determined from the performance index determination module 130. For example, the result showing a negative work package hour variance value or a work package hour performance index less than 1.0 means that the budgeted hours of work package actually completed is less than the budgeted hours of work package planned to be completed. Then the fifth performance determination module 136 can determine that the fifth performance index is undesirable and transfer the determination result output to the performance result output module 140, so the performance result output module 140 can output a performance warning. This underperformance warning output for example will be displayed on the screen, such as using a red font or display lights. More specifically, if the performance is undesirable, the underperformance warning output can be a warning by the lights in the performance result output table.

In another example, the result showing a negative fifth hour variance value or a fifth hour performance index less than 1.0 means the budgeted hours of work package actually completed is less than the actual required hours of the work package actually completed. In other word, the time invested on the work package is greater than originally scheduled investment of time, i.e. the implementation of the project has poor efficiency. Then, the fifth performance determination module 136 can determine that the fifth performance index is undesirable and transfer the determination result to the performance result output module 140, so the performance result output module 140 can output a warning of underperformance.

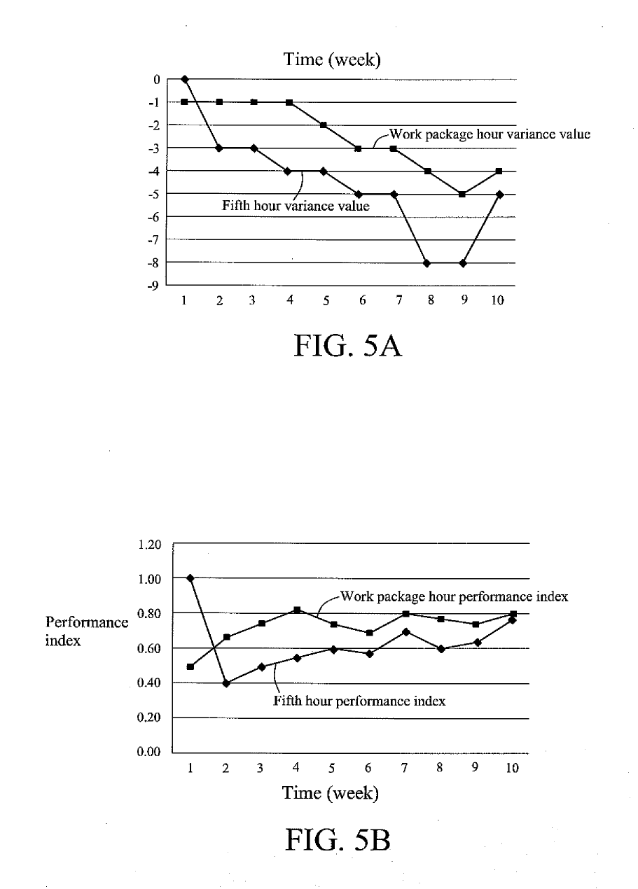

Refer to FIG. 5A and FIG. 5B, FIG. 5A shows an output result of a work package hour variance value and a fifth hour variance value, and FIG. 5B shows an output result of a work package hour performance index and a fifth hour performance index. FIG. 5A shows the changes of the work package hour variance value and the fifth hour variance value over time. FIG. 5B shows the changes of the work package hour performance index and the fifth hour performance index over time.

Similarly, the results showing a negative work breakdown structure hour variance value or a hour work breakdown structure performance index less than 1.0 means the earned hours of WBS actually completed is less than the expected hours of the work breakdown structure planned to be completed. As simply the actual earned value is less than the planned earned value. Then the fourth performance determination module 135 can determine that the fourth performance index is undesirable and transfer the determination result to the performance result output module 140, so the performance result output module 140 can output a warning of underperformance. The results showing a negative fourth hour variance or a fourth hour performance index less than 1.0 means that the earned hours of WBS actually completed is less than the actual hours of WBS actually completed, that means the time invested on a work breakdown structure is greater than the originally scheduled investment of time, so that the implementation efficiency of the project is poor. Then, the fourth performance determination module 135 can determine that the fourth performance index is undesirable, and transfer the determination result to the performance result output module 140, so the performance result output module 140 can output a warning of underperformance.

In another example, the results showing a negative activity hour variance value or a activity hour performance index less than 1.0 means the earned hours of activity actually completed is less than the budgeted hours of activity to be completed. Then, the sixth performance determination module 138 can determine that the sixth performance index is undesirable and transfer the performance result to the performance result output module 140, so the performance result output module 140 can output a warning of underperformance.

Again, in another example, the results showing a negative sixth hour work variance value or a sixth hour work performance index value less than 1.0 means the earned hours of activity actually completed is less than the actual required hours of the activity actually completed, that means the time actually invested on the activity is more than originally scheduled investment time, so that the implementation efficiency of the project is poor. Then, the sixth performance determination module 138 can determine that the sixth performance index is undesirable and the determination result can be output to the performance result output module 140, so the performance result output module 140 can output a warning of underperformance. More specifically, the performance result output module 140 can combine the first to the sixth performance determination modules' performance determination result outputs to the statistical tables and give the poor performance index a warning, so the manager can make a more efficient project performance monitoring.

From the above, the project management system 100 of the embodiment not only can manage the project's performance based on “the number of work breakdown structure”, “the number of work package” and “the number of activity” but also can manage the project's performance based on hours. Thus, compared to the traditional EVM, which can only use monetary unit to measure the performance of the project, the project management system 100 can use other units to measure the performance of the project, therefore, the project management system 100 of the embodiment can manage more project types. Hence, a project or a enterprise not implementing a project hour management and a material cost management can use “the number of work breakdown structure”, “the number of work package” and “the number of activity” of the project management system 100 to manage the project's performance.

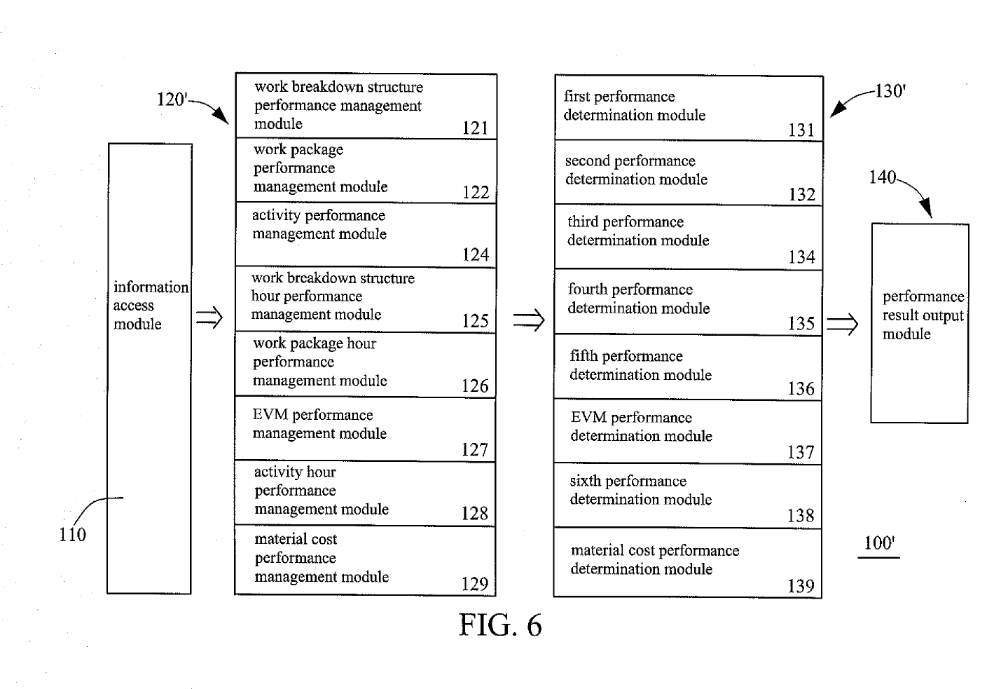

In addition, the project management system of the present invention may also contain the traditional EVM, as a project management system of the present invention can also use the non-monetary unit to measure the project's performance. Referring to FIG. 6, the FIG. 6 shows the second embodiment of the project management system of the present invention. In the project management system 100′ of this embodiment, the same elements as the first embodiment will be denoted by the same reference numerals and will not described in detail again. Compared to the performance management module 120 in FIG. 3A, the performance management module 120′ of the embodiment further includes an EVM performance management module 127 and the performance index determination module 130′ further includes an EVM performance management module 137. By the EVM performance management module 127 and the EVM performance management module 137, the traditional EVM performance measurement mode can be performed.

Therefore, by the project management system 100′, except using the non-monetary unit to measure the performance of a project, the project manager also can use the number of the work breakdown structures and work packages, the activity number and the hours to measure the project's performance. Therefore, the project management system 100′ can measure the project performance more comprehensively, thereby enhancing the effectiveness of project management.

The performance management module 120′ further includes a material cost performance management module 129, the material cost performance management module 129 by a planned cost of material, a earned cost of material and a actual cost of material manages the material cost for a project. The planned cost of material, earned cost of material, and actual cost of material is part of the project information, for more detailed definition please see Table 1.

After comparing the planned cost of material, the earned cost of material and the actual cost of material, the material cost performance management module 129 can output a seventh performance index, the seventh performance index includes a material cost variance, a material cost progress variance, a material cost performance index and a material cost progress performance index, wherein:

The material cost variance=earned cost of material−actual cost of material,

The material cost progress variance=earned cost of material−planned cost of material,

The material cost performance index=earned cost of material/actual cost of material,

The material cost progress performance index=earned cost of material/planned cost of material,

Compared to the performance index determination module 130 in FIG. 3A, the performance index determination module 130′ of the embodiment further includes a material cost performance determination module 139 and the material cost performance determination module 139 can determine that the performance result reached by the project based on the seventh performance index. For example, the result showing a negative material cost variance means the material cost representative of the work actually completed is less than the actual required material cost for the work actually completed. The result showing a material cost performance index less than 1.0 means the material cost representative of the work actually completed is greater than the actual required material cost for the work actually completed and this means the material cost on implementation of the project may be over cost. At this point, the material cost performance determination module 139 can determines the seventh performance index is undesirable and transfer the performance result to the performance result output module 140 to output a warning of underperformance.

Compared to the traditional EVM, the project management system 100′ can manage the material costs individually, so the project using only material cost as performance measurement unit can be managed by the project management system 100′. In other words, the project management system 100′ can measure the project's performance more comprehensively, thereby enhancing the effectiveness of project management.

In addition, the project information inputted via the user information access module 110 further includes the information about the relationship between all the work breakdown structures, the work packages, the activities and the project members in charge of. In this way, the managers can use the project management system 100 or 100′ to detect the work packages or the activities that the project members are currently in charged of and rapidly display the project performance of each project member, so as to evaluate and manage the performance of all the work breakdown structures of each project.

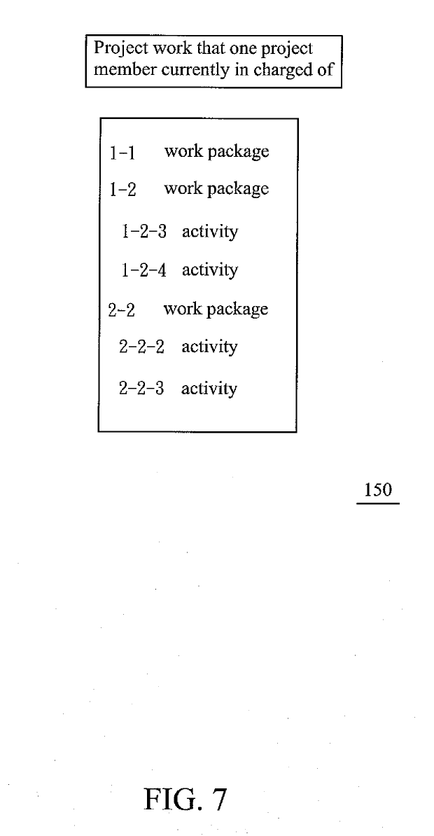

For example, please refer to FIG. 7, FIG. 7 shows a user interface 150 of the project management system 100. The user interface 150 can show all of the work packages and activities that one project member is currently in charged of. Besides that, this user interface 150 can also show the progress of the work packages and activities. In other words, all of the work breakdown structure, the work package, and the activity that one project member currently in charge of can be regarded as one project, so it is possible to measure the performance of each project member. In this way, the managers can manage the multiple projects, multiple members and all the levels at the same time.

For example, please also refer to FIG. 2D and FIG. 7, the current project work of project member N1 of the second level can be shown in the user interface 150 of the project management system 100. From the user interface 150, the current work package and activity of the project member N1 can be known. Moreover, the performance of the current work packages and the activity of the project member N1 can be viewed or checked by similar way shown in FIG. 4A˜FIG. 4B and FIG. 5A˜FIG. 5B.

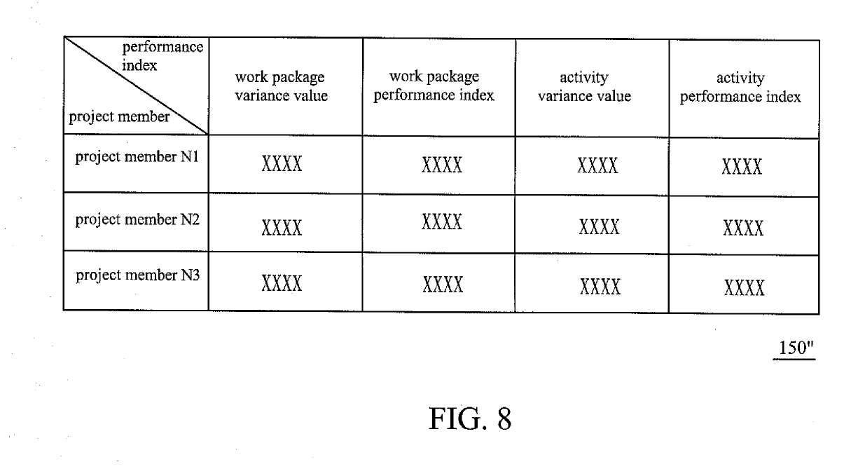

Please refer to FIG. 8, FIG. 8 shows the project members N1˜N3's performance displayed on the user interface 150″. In FIG. 8, in order to show clearly, it only lists the second performance index (i.e. work package variance values and work package performance index) and the third performance index (i.e. the activity variance value and activity performance index). However, The person having ordinary skill in the art should understand that FIG. 8 is only a schematic figure and the first performance index and the fourth-seventh performance indexes can also be displayed on the user interface 150. In FIG. 8, the project members N1˜N3's performance value (in FIG. 8 shown as “x x x x” part), for example, depends on performance values of the subordinate of the project members N1˜N3. For example, performance values of the project members N1˜N3 can be sum of the performance values of the subordinate of the project members N1˜N3. Taking the project member N1 as example, the work package variance value of the project member N1 is the sum of that of the the project members N11˜project members N13. The work package variance value of the project members N11 is the sum of that of the project members N11-1˜project members N11-n. In this way, the project management system of the present invention not only can evaluate the performance of the project members (for example: Project members N11-1) in the bottom layer but also can evaluate the performance of the project members of higher-levels.

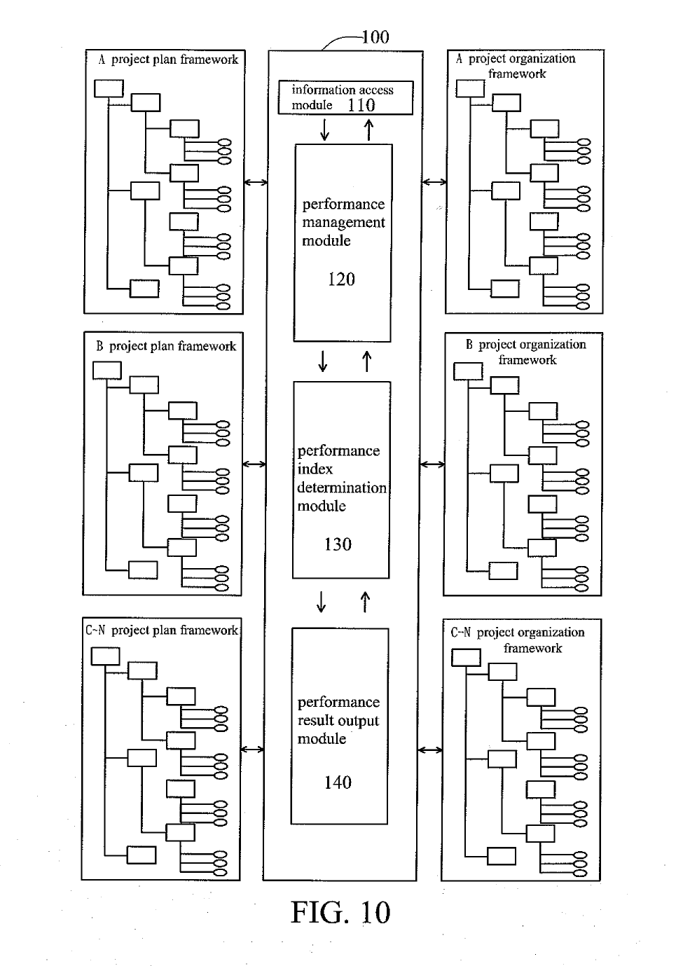

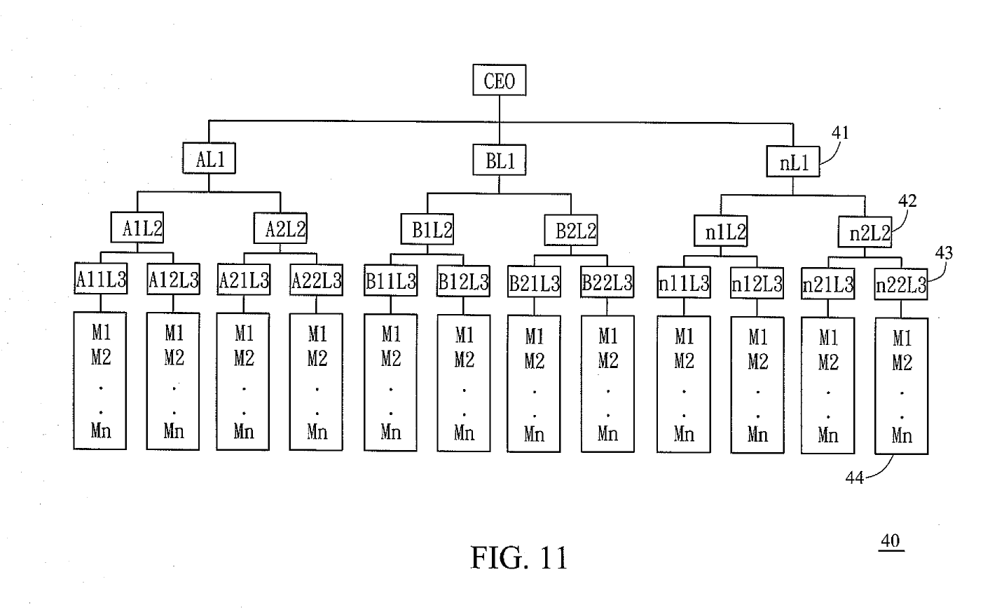

Please refer to FIG. 10, FIG. 10 shows a third embodiment of the project management system of the present invention. FIG. 10 shows that project management system 100 can manage multiple projects at the same time and do the cross-project management. In FIG. 10, each project structure (including the work breakdown structures and activity list thereof) corresponds to one of the project organization structure (including organizational breakdown structure and the person in charge of). For example, B project structure corresponds to B project organization. In this embodiment, the B project structure is assumed to be FIG. 2C's project structure and B project member organization is assumed to be the project organization shown in FIG. 2D. In addition, since each work package or each activity corresponds to a project member in charge of, so by the project management system 100 the project manager can clearly understand the corresponding relationship between the work package or the activity and the project member in charge of. Hereinafter, more detailed descriptions are provided as below.

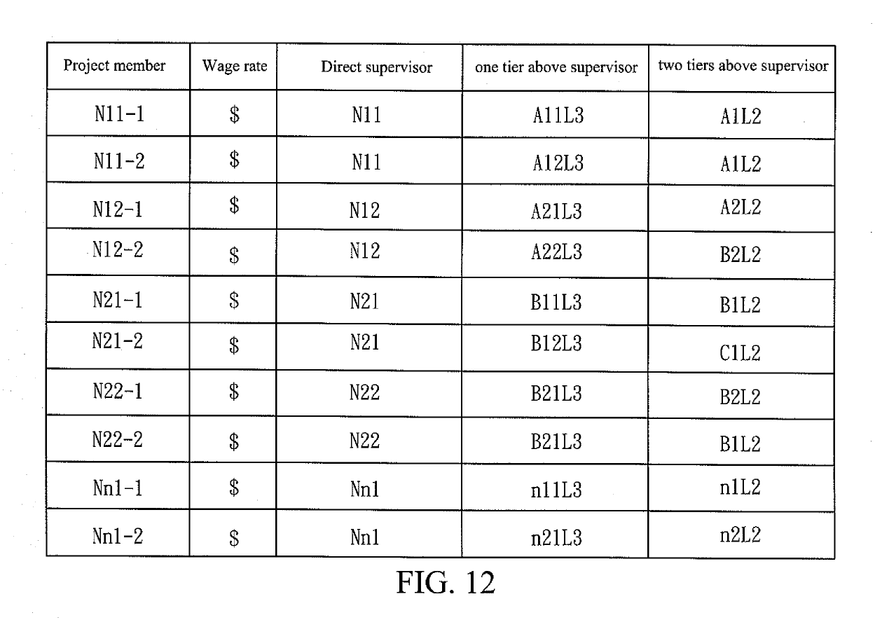

Please also refer to FIG. 2D and FIG. 11, FIG. 11 shows functional organization structure of an organization. In the functional organization structure 40, CEO is responsible for coordinating the operations of the entire organization, which is is divided into four levels, first level 41, second level 42, third level 43 and the fourth level 44. In general, in FIG. 2D the project organization only shows a temporary organizational structure of the organization, which exists only for the project and will be dissolved after the end of the project. The organization in which the functional organizational structure and project organization coexist, is also known as matrix-type project organization and is the most common project organization. For example, the project members N11 and project members N11-1 in the functional organization 40 may both belong to the fourth level 44, but in the project organization the project members N11 are the supervisors of the project members N11-1. By inputting the hierarchical relationship information shown in the FIG. 2D and FIG. 11 into the project management system 100 through the information access module 110 in FIG. 10, a manager can control the nexus between the functional organization and the project organization (shown as FIG. 12), which also defines who should bear joint management responsibility, so as to measure the management responsibilities of the project manager or each level of the functional organization with performance management.

Based on FIG. 12, the person of ordinary skill in the art can understand clearly the supervisor of the project member N11 in the functional organization 40 is manager A11L3 and the manager A11L3 is also under the control and management of manager A1L2. Thus, even if the manager A11L3 and project member N11 do not belong to the same project, by the project management system 100 of the embodiment, the manager A11L3 can also check the performance of the project member N11 in another project. In addition, performance management module 120 can associate the performance of the project member N11 in one project with the performance of the manager A11L3. In more detail, the performance of the managers A11L3 can be the sum of the performance of the managers M1˜Mn and the performance of the manager A1L2 can be the sum of the performance of the manager A11L3 and the manager A12L3. Thus the manager A11L3 would have the incentives to focus on the performance of the project member N11 on the other project.

Please refer to the FIG. 9 and FIG. 10, with the project management system 100, it is possible to control the work in each project that each member of an organization is in charge of, so as to more accurately measure the working load of each organizational member. In FIG. 9, the planned hours of activity and the actual hours of activity of all activities for one project member in some time interval can be summed up, so as to track and manage the resource load and the actual working hours.

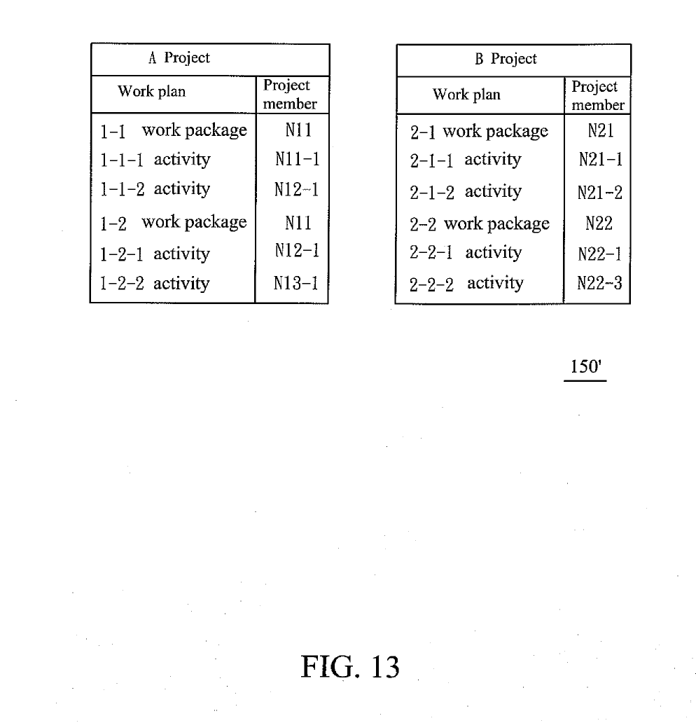

Also, refer to FIG. 13, the user interface 150′ can present the work breakdown structures of the company's current ongoing projects (for example, A project and B project) and the project members in charge of.

Although the description above contains many specifics, these are merely provided to illustrate the invention and should not be construed as limitations of the invention's scope. Thus it will be apparent to those skilled, in the art that various modifications and variations can be made in the system and processes of the present invention without departing from the spirit or scope of the invention.

What is claimed is:

1. A project management system configured to manage at least one project and adapted for integrating multiple projects in order to control a department or interdepartmental and multi-level project management performance, the project management system comprising:
an information access module configured for at least one user to input multiple pieces of project information, each piece of the project information corresponding to one of the projects, and the project information including multiple pieces of work unit information;
a performance management module configured to compare a work unit planned value and a work unit earned value to get their difference and transforming the difference to a performance index;
a performance index determination module configured to determine the project's performance results reached according to the performance index; and
a performance result output module configured to output the performance results from the performance index determination module.

2. The project management system of claim 1, wherein the work unit information includes a work breakdown structure information, the work breakdown structure information includes a planned numbers of WBS and a earned numbers of WBS;
the performance management module includes a work breakdown structure performance management module, the work breakdown structure performance management module compares the planned numbers of WBS with the earned numbers of WBS to get their difference and transforms the difference to a first performance index;
the performance index determination module determines the project's performance results reached according to the first performance index;
wherein the first performance index includes at least one of following:
a work breakdown structure variance value: the earned numbers of WBS minus the planned numbers of WBS; and
a work breakdown structure performance index: the earned numbers of WBS divided by the planned numbers of WBS;
when the performance index determination module determines that the work breakdown structure variance value is negative or that the work breakdown structure performance index is lower than 1.0, the performance result output module outputs a warning of underperformance.

3. The project management system of claim 2, wherein the work unit information includes a work package information, the work package information includes a planned numbers of work package and a earned numbers of work package;
the performance management module further includes a work package performance management module, the work package performance management module compares the planned numbers of work package with the earned numbers of work package to get their difference and transforms the difference to a second performance index;
the performance index determination module can determine the project's performance results according to the second performance index;
wherein the second performance index includes at least one of following:
a work package variance value: the earned numbers of work package minus the planned numbers of work package; and
a work package performance index: the earned numbers of work package divided by the planned numbers of work package;
when the performance index determination module determines that the work package variance value is negative or that the work package performance index is lower than 1.0, the performance result output module outputs a warning of underperformance.

4. The project management system of claim 3, wherein the work unit information includes an activity information, the activity information includes an planned numbers of activity and a earned numbers of activity;
the performance management module further includes a activity performance management module, the activity performance management module compares the planned numbers of activity with the earned numbers of activity to get their difference and transforms the difference to a third performance index;
the performance index determination module determines the project's performance results according to the third performance index;
wherein the third performance index includes at least one of following:
a activity variance value: the earned numbers of activity minus the planned numbers of activity; and
a activity performance index: the earned numbers of activity divided by the planned numbers of activity;
when the performance index determination module determines that the activity variance value is negative or that the activity performance index is lower than 1.0, the performance result output module outputs a warning of underperformance.

5. The project management system of claim 4, wherein the project information further includes a planned hours of WBS, a earned hours of WBS, a actual hours of WBS, a planned hours of work package, a earned hours of work package, a actual hours of work package, an planned hours of activity, an earned hours of activity, and an actual hours of activity;
the performance management module further includes a work breakdown structure hour performance management module, a work package hour performance management module, and an activity hour performance management module;
the work breakdown structure hour performance management module compares the planned hours of WBS, the earned hours of WBS and the actual hours of WBS to get their differences and transforms the differences into a fourth performance index;
the work package hour performance management module compares the planned hours of work package, the earned hours of work package and the actual hours of work package to get their differences and transforms the differences into a fifth performance index;
the activity hour performance management module compares the planned hours of activity, the earned hours of activity and the actual hour value of work activity to get their differences and transforms the differences into a sixth performance index;
the performance index determination module determines the project's performance results reached according to the fourth performance index, the fifth performance index and the sixth performance index;
wherein the fourth performance index includes at least one of following:
a work breakdown structure hour variance value: the earned hours of WBS minus the planned hours of WBS;
a fourth hour variance value: the earned hours of WBS minus the actual hour value;
a work breakdown structure hour performance index: the earned hours of WBS divided by the planned hours of WBS; and
a fourth hour performance index: the earned hours of WBS divided by the actual hours of WBS;
wherein the fifth performance index includes at least one of following:
a work package hour variance value: the earned hours of work package minus the planned hours of work package;
a fifth hour variance value: the earned hours of work package minus the actual hour value;
a work package hour performance index: the earned hours of work package divided by the planned hours of work package; and
a fifth hour performance index: the earned hours of work package divided by the actual hours of work package;
wherein the sixth performance index includes at least one of following:
an activity hour variance value: the earned hours of activity minus the planned hours of activity;
a sixth hour variance value: the earned hours of activity minus the actual hour value;
an activity hour performance index: the earned hours of activity divided by the planned hours of activity; and
a sixth hour performance index: the earned hours of activity divided by the actual hours of activity;
when the performance index determination module determines that the fourth hour variance value is negative or that the work breakdown structure hour variance value is negative or that the fourth hour performance index is lower than 1.0 or that the work breakdown structure hour performance index is smaller than 1.0, the performance resulting module output a warning of underperformance; when the performance index determination module determines that the fifth hour variance value is negative or that the work package hour variance value is negative or that the fifth hour performance index is lower than 1.0 or that the work package hour performance index is lower than 1.0, the performance result output module outputs a warning of underperformance; when the performance index determination module determines that the activity hour variance value is negative or that the sixth hour variance value is negative or that the activity hour performance index is lower than 1.0 or that the sixth work hour performance index is lower than 1.0, the performance result output module outputs a warning of underperformance.

6. The project management system of claim 5, further comprising a user interface, wherein the project information further includes and the user interface displays the information about a project member with respect to all the work packages and the activities this project member in charge of, thereby the project managers can know all the work packages and the activities that this project member currently in charge of and can regard the work packages and the activities that this project member currently in charge of as one project.

7. The project management system of claim 5, wherein the project information further comprises information of a functional organization structure and a project hierarchy structure, wherein the performance management module sums up performance values of the project members in a bottom layer as performance values of project members in a top layer, and the project members in the top layer and a portion of the project members in the bottom layer are responsible for different projects respectively.

8. The project management system of claim 1, wherein the project information includes multiple pieces of activity information, the activity information includes an planned numbers of activity and an earned numbers of activity;
the performance management module further includes an activity performance management module, the activity performance management module compares the planned numbers of activity and the earned numbers of activity to get their difference, and transforms the difference to a third performance index;
the performance index determination module determines the project's performance results according to the third performance index;
wherein the third performance index includes at least one of following:
an activity variance value: the earned numbers of activity minus the planned numbers of activity; and
an activity performance index: the earned numbers of activity divided by the planned numbers of activity;
when the performance index determination module determines that the activity variance value is negative or that the activity performance index is lower than 1.0, the performance result output module outputs a warning of underperformance.

9. The project management system of claim 5, further comprising a user interface, wherein the project information comprises information of a project member with respect to all the activities this project member is in charge of, the user interface displays the summation of the planned hours of activity of all the activities of this project member, by this information a manager can detect a working load of this project member and manage the actual invested hour of this project member.

10. A project management system configured to manage at least one project and adapted for integrating multiple projects in order to control a department or interdepartmental and multi-level project management performance, the project management system comprising:
an information access module used for at least one user to input multiple pieces of project information, each piece of project information corresponding to one of the projects, the project information including multiple pieces of work breakdown structure information, and the work breakdown structure information including a planned hours of WBS, a earned hours of WBS and a actual hours of WBS;
a performance management module including a work breakdown structure hour performance management module, the work breakdown structure hour performance management module comparing the planned hours of WBS, the earned hours of WBS and the actual hours of WBS to get their differences and transforming the differences into a fourth performance index;
a performance index determination module configured to determine the project's performance results reached according to the fourth performance index; and
a performance result output modules outputs the performance result from the performance index determination module;
wherein the fourth performance index includes at least one of following:
a work breakdown structure hour variance value: the earned hours of WBS minus the planned hours of WBS;
a fourth hour variance value: the earned hours of WBS minus the actual hour value;
a work breakdown structure hour performance index: the earned hours of WBS divided by the planned hours of WBS; and
a fourth hour performance index: the earned hours of WBS divided by the actual hours of WBS;
when the performance index determination module determines that the fourth hour variance value is negative or that the hour work breakdown structure variance value is negative or that the fourth hour performance index is lower than 1.0 or that the hour work breakdown structure performance index is smaller than 1.0, the performance resulting module outputs a warning of underperformance.

11. The project management system of claim 10, wherein the project information further includes multiple pieces of work package information, the work package information includes a planned hours of work package, a earned hours of work package and a actual hours of work package;
the performance management module further includes a work package hour performance management module, the work package hour performance management module compares the planned hours of work package, the earned hours of work package and the actual hours of work package to get their differences and transforms the differences into a fifth performance index;
the performance index determination module determines the project's performance results reached according to the the fifth performance index;
wherein the fifth performance index includes at least one of following:
a work package hour variance value: the earned hours of work package minus the planned hours of work package;
a fifth hour variance value: the earned hours of work package minus the actual hour value;
a work package hour performance index: the earned hours of work package divided by the planned hours of work package; and
a fifth hour performance index: the earned hours of work package divided by the actual hours of work package;
when the performance index determination module determines that the fifth hour variance value is negative or that the work package hour variance value is negative or that the fifth hour performance index is lower than 1.0 or that the work package hour performance index is lower than 1.0, the performance result output module outputs a warning of underperformance.

12. The project management system of claim 11, wherein the project information further includes multiple pieces of activity information, the activity information further includes an planned hours of activity, an earned hours of activity and an actual hours of activity;
the performance management module further includes an activity hour performance management module, the activity hour performance management module compares the planned hours of activity, the earned hours of activity and the actual hour value of work activity to get their differences and transforms the differences into a sixth performance index;
Wherein the sixth performance index includes at least one of following:
an activity hour variance value: the earned hours of activity minus the planned hours of activity;
a sixth hour variance value: the earned hours of activity minus the actual hour value;
an activity hour performance index: the earned hours of activity divided by the planned hours of activity; and
a sixth hour performance index: the earned hours of activity divided by the hour actual hours of activity;
when the performance index determination module determines that the activity hour variance value is negative or that the sixth hour variance value is negative or that the activity hour performance index is lower than 1.0 or that the hour work performance index is lower than 1.0, the performance result output module outputs a warning of underperformance.

13. The project management system of claim 12, further comprising a user interface, wherein the project information comprises information of a project member with respect to all the activities this project member is in charge of, the user interface displays the summation of the planned hours of activity of all the activities of this project member, by this information a manager can detect a working load of this project member and manage the actual invested hour of this project member.

14. A project management system configured to manage at least one project and adapted for integrating multiple projects in order to control a department or interdepartmental and multi-level project management performance, the project management system comprising:
an information access module configured for at least one user to input multiple pieces of project information, each piece of project information corresponding to one of the projects, and the project information including multiple pieces of activity information, the activity information including an planned hours of activity, an earned hours of activity and an actual hours of activity;
a performance management module including an activity hour performance management module, the activity hour performance management module comparing the planned hours of activity, the earned hours of activity and the actual hour value of work activity to get their differences and transforming the differences to a sixth performance index;
a performance index determination module configured to determine the project's performance results reached according to the sixth performance index; and
a performance result output module configured to show the performance result from the performance index determination module;
wherein the sixth performance index includes at least one of following:
an activity hour variance value: the earned hours of activity minus the planned hours of activity;
a sixth hour variance value: the earned hours of activity minus the actual hour value;
an activity hour performance index: the earned hours of activity divided by the planned hours of activity; and
a sixth hour performance index: the earned hours of activity divided by the hour actual hours of activity;
when the performance index determination module determines that the activity hour variance value is negative or that the sixth hour variance value is negative or that the activity hour performance index is lower than 1.0 or that the sixth hour performance index is lower than 1.0, the performance result output module outputs a warning of underperformance.

15. The project management system of claim 14, further comprising a user interface, wherein the project information comprises information of a project member with respect to all the activities this project member is in charge of, the user interface displays the summation of the planned hours of activity of all the activities of this project member, by this information a manager can detect a working load of this project member and manage the actual invested hour of this project member.
